(19) United States
(12) Patent Application Publication
(10) Pub. No.: US 2024/0340446 A1
(43) Pub. Date: Oct. 10, 2024

(54) ENCODING RESOLUTION CONTROL

(71) Applicant: TELEFONAKTIEBOLAGET LM ERICSSON (PUBL), Stockholm (SE)

(72) Inventors: Kenneth ANDERSSON, Gävle (SE); Jacob STRÖM, Stockholm (SE); Ruoyang YU, Täby (SE)

(73) Assignee: TELEFONAKTIEBOLAGET LM ERICSSON (PUBL), Stockholm (SE)

(21) Appl. No.: 18/573,838

(22) PCT Filed: Jun. 30, 2022
(86) PCT No.: PCT/EP2022/068062

§ 371 Date: Dec. 22, 2023

Related U.S. Application Data
(60) Provisional application No. 63/216,779, filed on Jun. 30, 2021.

(51) Int. Cl. H04N 19/59; G06V 10/74; H04N 19/117; H04N 19/159; H04N 19/176; H04N 19/177; H04N 19/184

(52) U.S. Cl. CPC H04N 19/59; G06V 10/761; H04N 19/117; H04N 19/159; H04N 19/176; H04N 19/177; H04N 19/184

(57) ABSTRACT

Methods and devices for determining video picture resolution. A first source picture is obtained and a first reduced resolution picture is generated based on the first source picture. A first similarity metric is determined for the first reduced resolution picture and the first source picture. A picture resolution is selected based at least in part on the first similarity metric.

### TECHNICAL FIELD

This disclosure relates to apparatuses and methods for image or video processing. Some aspects of this disclosure relate to apparatuses and methods for encoding, decoding, and/or compression, including for adaptive video streaming or conferencing.

### BACKGROUND

In certain aspects, a video (e.g., comprising a video sequence) comprises of a series of pictures, where each picture has one or more components. Often, each component can be described as a two-dimensional rectangular array of sample values. It is common that a picture has three components: one luma component Y, where the sample values are luma values: and two chroma components Cb and Cr, where the sample values are chroma values. The resolution of a picture usually refers to the size of the luma component of the picture. For example, a picture with resolution of 1920×1080 typically means that the width of the luma component of the picture is 1920, and the height of the luma component of the picture is 1080. However, resolution may refer to other components or values in some instances.

In video coding, each component can be split into blocks, where the coded video bitstream consists of a series of coded blocks. A block may be, for example, one two-dimensional array of samples. It is common in video coding that the picture is split into units that cover a specific area of the picture, where each unit consists of all blocks from all components that make up that specific area and each block belongs fully to one unit. The macroblock in H.264 and the Coding unit (CU) in the High Efficiency Video Coding (HEVC) standard are examples of units. A block can alternatively be a two-dimensional array that a transform used in coding is applied to. These blocks are often referred to as “transform blocks.” A block can also be a two-dimensional array that a single prediction mode is applied to. These blocks can be called “prediction blocks.” However, the word “block” is not necessarily tied to one of these definitions, and the descriptions herein can apply to different definitions.

Versatile Video Coding (VVC) is a block-based video codec standardized by International Telecommunication Union-Telecommunication (ITU-T) and Motion Picture Experts Group (MPEG) that utilizes both temporal and spatial prediction. Spatial prediction is achieved using intra (I) prediction from within a current picture. Temporal prediction is achieved using uni-directional (P) or bi-directional inter (B) prediction on a block level from previously decoded reference pictures. In the encoder, the difference between the original sample data and the predicted sample data, referred to as the residual, is transformed into the frequency domain, quantized, and then entropy coded before being transmitted together with necessary prediction parameters such as prediction mode and motion vectors, which are also entropy coded. Typically, the decoder performs entropy decoding, inverse quantization, and inverse transformation to obtain the residual and then adds the residual to an intra or inter prediction to reconstruct a picture.

In certain aspects, a residual block may consist of samples that represent sample value differences between sample values of the original source blocks and the prediction blocks. The residual block can be processed using a spatial transform. In the encoder, the transform coefficients are quantized according to a quantization parameter (QP), which controls the precision of the quantized coefficients. The quantized coefficients can be referred to as residual coefficients. A high QP value would result in low precision of the coefficients and thus low fidelity of the residual block. In certain aspects, a decoder receives the residual coefficients, and applies inverse quantization and an inverse transform to derive the residual block.

In video coding, a current picture with a current resolution can be rescaled to a different target resolution. A rescaling filter is usually involved in the rescaling process. When the target resolution is smaller than the current resolution, the rescaling operation is often referred to as downscaling operation. The rescaling filters used in the downscaling operation are usually low-pass filters to reduce the risk of introducing aliasing artifacts in the downscaled picture. High frequency details that exist in the source resolution are sometimes lost during the downscaling process. When the target resolution is greater than the current resolution, the rescaling operation is referred to as upscaling. If the current picture has been previously downscaled from another original picture at a higher resolution, the upscaling process is typically not able to fully recover or reproduce the high frequency details that exist in the original picture.

There remains a need for devices and methods to select and apply encoding resolutions for pictures and sets of pictures such that one or more of coding efficiency and subjective quality may be improved.

### SUMMARY

According to embodiments, a method is provided for determining resolution, which comprises: obtaining a first source picture: generating a first reduced resolution picture based on the first source picture: determining a first similarity metric for the first reduced resolution picture and the first source picture, and selecting a picture resolution based at least in part on the first similarity metric. In some embodiments, determining the first similarity metric comprises: (i) upscaling the first reduced resolution picture to the resolution of the first source picture to generate an up-scaled picture, and (ii) comparing the up-scaled picture to the first source picture. The method may further comprise performing an encoding operation with the selected picture resolution. In some embodiments, selecting a picture resolution comprises comparing the first similarity metric to at least one threshold.

According to embodiments, an apparatus is provided that is configured to: obtain a first source picture: generate a first reduced resolution picture based on the first source picture: determine a first similarity metric for the first reduced resolution picture and the first source picture, and select a picture resolution based at least in part on the first similarity metric. In certain aspects, determining the first similarity metric comprises: (i) upscaling the first reduced resolution picture to the resolution of the first source picture to generate an up-scaled picture, and (ii) comparing the up-scaled picture to the first source picture.

According to embodiments, a decoder, encoder, network node, or other apparatus is provided that is configured to perform one or more of the methods described herein. In certain aspects, the device comprises memory and processing circuitry coupled to the memory.

According to embodiments, a computer program comprising computer program code stored on a non-transitory computer readable medium is provided, which, when run on a decoder, encoder, network node, or other apparatus causes the device to perform one or more of the methods described herein. In one embodiment, there is provided a carrier containing the computer program wherein the carrier is one of an electronic signal, an optical signal, a radio signal, and a computer readable storage medium.

An advantage of one or more embodiments disclosed herein is that the described methods and devices can, with a small amount of computational power, select the encoding resolution for a set of pictures in a way that improves coding efficiency and also improves subjective quality.

### BRIEF DESCRIPTION OF THE DRAWINGS

The accompanying drawings, which are incorporated herein and form part of the specification, illustrate various embodiments.

FIG. 1 illustrates an example of a video coding picture hierarchy.

FIG. 2 illustrates a system according to an embodiment.

FIG. 3 is a schematic block diagram of an encoder according to an embodiment.

FIG. 4 is a schematic block diagram of a decoder according to an embodiment.

FIG. 5 is a block diagram of an apparatus according to an embodiment.

FIGS. 6A and 6B are flowcharts illustrating processes according to embodiments.

FIGS. 7 and 8 illustrate examples of rate-distortion/quality curves for a picture, or group of pictures, in accordance with some embodiments.

FIGS. 9A-9E are tables according to some embodiments.

### DETAILED DESCRIPTION

Reference picture resampling (RPR) is a VVC tool that can be used to enable switching between different resolutions in a video bitstream without encoding a startup of a new sequence with an intra picture. This gives more flexibility to adapt resolution to control bitrate, which can be of used in, for example, video conferencing or adaptive streaming. RPR can make use of previously encoded pictures of lower or higher resolution than the current picture to be encoded by re-scaling them to the resolution of the current picture as part of inter prediction of the current picture.

In adaptive streaming, for example, a video sequence is typically divided into segments (e.g., each 1-5 seconds long). These segments are encoded at a variety of resolutions and qualities so that multiple segments will cover a given time interval. All segments are then typically stored on the server side. When the decoder wants to display video corresponding to a certain time interval, it can choose from the many segments varying in bit rate and quality. The decoder typically determines which segment to request based on preferences or transmission capabilities for resolution. This may mean that video quality will increase and decrease during playback as a function of network throughput. For instance, when network throughput is high, the decoder may select high bit rate segments that provide high quality and/or high resolution, and when network throughput is lower, resolution, quality, and bit rate may go down while still providing a smooth playback experience without stopping to buffer. Current approaches for adaptive streaming can be very time consuming and/or costly in terms of computational power, and thus, likely not applicable in cases when encoding time and/or power consumption is at a premium.

In the case of pre-recorded content, the encoding for adaptive streaming can be performed once, and the segments can then be stored on the server to serve many decoder play back requests. In this case, the encoding does not have to be real-time. However, some adaptive streaming systems allow for live content. In this case, the encoder should be able to encode faster than real-time, since several segments may be produced for the same time interval. Just as in the case with pre-recorded content, these segments may be stored on the server and several viewers (clients) can then request these segments and decode them. Some of these clients may have poor network throughput, and thus, request low bit rate segments for a certain time interval. Other clients may enjoy high network throughput and request a high bit rate segment for the same time interval.

In video conferencing, especially when only two users are communicating point-to-point (rather than multipoint), the resolution or quality may be adjusted to adapt to the current transmission channel throughput. It may not be necessary to create several segments for the same time interval, and the encoding therefore does not need to happen faster than real-time. In this scenario, if the bit rate is too high, the decoder can signal it to the encoder, which can then lower the quality or resolution of subsequent frames, resulting in a lower bit rate for those future frames.

In what is often referred to as the “random access configuration,” intra coded pictures are positioned with a fixed interval (e.g., every second). Pictures between the intra picture are typically coded with a hierarchical B picture structure.

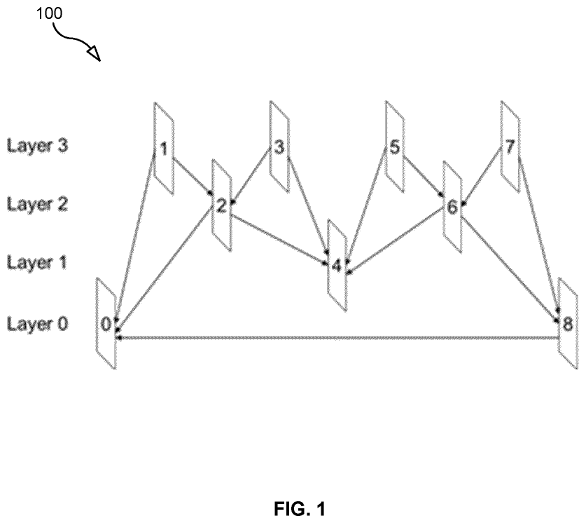

One example of a hierarchy 100 of pictures is shown in FIG. 1, with a structure using two reference pictures per picture and also showing temporal layers 0 to 3. This example uses 8 pictures: however, other numbers of picture may be used. In this example, picture 0 is coded first and then picture 8 is coded using picture 0 as its reference picture. Then picture 8 and picture 0 are used as reference pictures to code picture 4. Then, similarly, picture 2 and picture 6 are coded. Finally, pictures 1, 3, 5 and 7 are coded. Pictures 1, 3, 5 and 7 can be referred to as being on the highest hierarchical level, pictures 2, 4 and 6 on the next highest hierarchical level, picture 4 on the next lowest level, and picture 8 on the lowest level. Typically picture 1, 3, 5 and 7 are not used for reference of any other pictures. They may be called non-reference pictures. In video coding, hierarchies of 16 or 32 pictures are also commonly used.

When encoding at restricted bitrates, it can sometimes be useful to encode at a lower resolution rather than at the source resolution. Since VVC provides a technique for enabling flexible switching of resolution without requiring encoding of an intra picture at the switching point, it is possible to do this more efficiently than in previous standards. However, the existing VVC reference encoder lacks the ability to decide when to enable encoding at reduced resolution. For instance, VVC currently lacks effective encoder control for selecting when to use RPR.

There remains a need for improved devices and methods, for instance, to select and apply encoding resolutions for pictures and sets of pictures. Certain challenges presently exist. For instance, when compressing video at relatively low-bitrates, compression artifacts can overtake. In such a situation it may be better to compress video at a lower resolution, and then re-scale it to original resolution. However, always encoding in downscaled resolution and then upscaling for viewing gives a large penalty in coding efficiency for many sequences. For instance, if a sequence contains fine details, these details may be lost. Notwithstanding, some sequences can benefit greatly (e.g., in terms of coding efficiency) from being encoded in a downscaled resolution as compared to using the original resolution. This may be evident when the bitrate is restricted, and this benefit can be large since encoding in source resolution can give poor subjective quality.

In some embodiments, methods and devices are provided where the resolution for encoding a set of source pictures is controlled by examining a similarity metric for at least one source picture and at least one reduced resolution picture. Aspects of this disclosure describe a GOP-based selection method that decides whether to encode pictures in reduced resolution with RPR, or if it is better to encode them in the source resolution. The selection can be based on QP and picture self-similarity after re-scaling, for instance. In embodiments, the self-similarity test is only conducted on the first source picture in display order within each group of pictures (GOP). If the re-scaled picture is determined to have sufficient similarity with the source picture, all pictures in the GOP are encoded at reduced resolution. Otherwise, they are encoded in the source resolution.

In some embodiments, a method is provided for determining resolution for encoding. The method comprises obtaining (e.g., retrieving, receiving, and/or deriving) a first source picture: generating a first reduced resolution picture based on the first source picture: determining a first similarity metric for the first reduced resolution picture and the first source picture: selecting a picture resolution based at least in part on the first similarity metric, and performing an encoding operation with the selected picture resolution. In certain aspects, the method may further comprise comparing the first similarity metric to at least one threshold (e.g., to determine if the first reduced resolution picture and the first source picture are sufficiently similar). Encoding of the picture may be based, at least in part, on the similarity of the pictures. For instance, the method may comprise encoding with a resolution of the first source picture when the threshold is not satisfied, or encoding with a resolution of the first reduced resolution picture when the threshold is satisfied.

In certain aspects, the resolution for encoding a set of source pictures is determined based on how one or more pictures in the set of source pictures can maintain similarity with the source picture after reducing the source resolution to a reduced resolution. If the reduced resolution picture can maintain enough similarity to the source picture according to a metric, the source picture is encoded in a reduced resolution. Otherwise, it is encoded in the source resolution. According to embodiments, one or more techniques can also be applied to a set of images (e.g., an entire group or portion of a group). For instance, if a reduced resolution set of pictures is sufficiently similar to a set of source pictures according to a metric, the set of pictures are encoded in reduced resolution. Otherwise, they are encoded in the source resolution. In some embodiments, the similarity of the set is evaluated based on one or more (e.g., two) pictures of the set. In certain aspects, encoding approaches (e.g., selection of resolution) are further controlled by the expected quality level of the encoding, such that the reduced resolution approach is more likely to be used for lower quality levels.

For example, for a GOP hierarchy of 32 pictures, the first picture in display order is checked, and if it is sufficiently similar to the corresponding source picture, that picture and the next 31 pictures in display order are encoded at reduced resolution. Otherwise the first 32 pictures in display order are encoded at the source resolution. Then, based on an evaluation of picture 32, the encoding resolution for that picture and the following 31 pictures is decided. While a hierarchy of 32 pictures is used in this example, other sizes may be used according to embodiments.

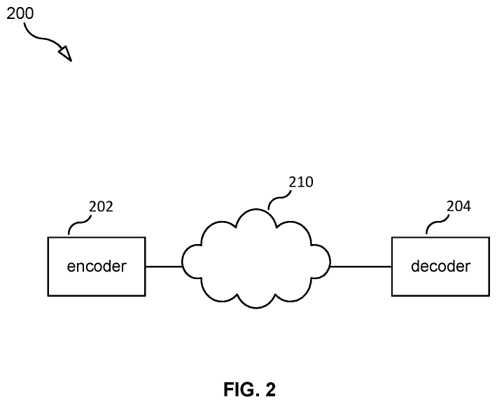

FIG. 2 illustrates a system 200 according to an example embodiment. System 200 includes an encoder 202 in communication with a decoder 204 via a network 210. The network 210 may be, for example, the Internet or other network.

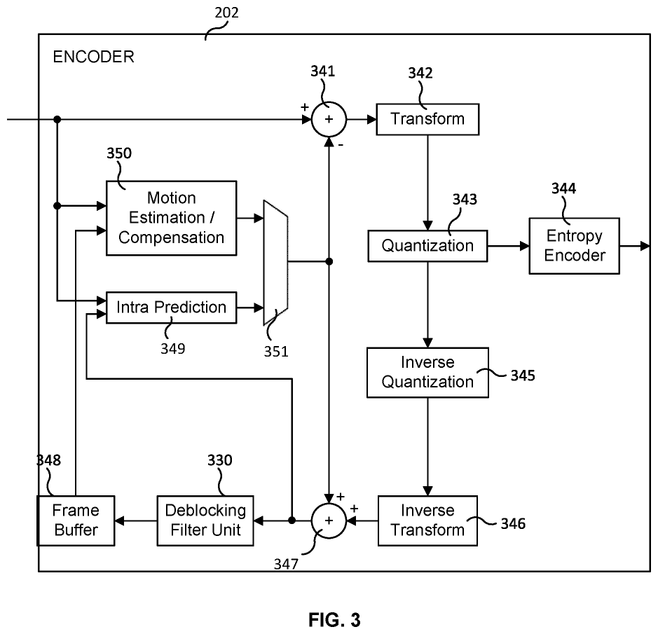

FIG. 3 is a schematic block diagram of encoder 202 for encoding a block of pixel values (hereafter “block”) in a video frame (picture) of a video sequence according to an embodiment. A current block is predicted by performing a motion estimation by a motion estimator 350 from an already provided block in the same frame or in a previous frame. The result of the motion estimation is a motion or displacement vector associated with the reference block, in the case of inter prediction. The motion vector is utilized by a motion compensator 350 for outputting an inter prediction of the block. An intra predictor 349 computes an intra prediction of the current block. The outputs from the motion estimator/compensator 350 and the intra predictor 349 are input in a selector 351 that either selects intra prediction or inter prediction for the current block. The output from the selector 351 is input to an error calculator in the form of an adder 341 that also receives the pixel values of the current block. The adder 341 calculates and outputs a residual error as the difference in pixel values between the block and its prediction. The error is transformed in a transformer 342, such as by a discrete cosine transform, and quantized by a quantizer 343 followed by coding in an encoder 344, such as by entropy encoder. In inter coding, also the estimated motion vector is brought to the encoder 344 for generating the coded representation of the current block. The transformed and quantized residual error for the current block is also provided to an inverse quantizer 345 and inverse transformer 346 to retrieve the original residual error. This error is added by an adder 347 to the block prediction output from the motion compensator 350 or the intra predictor 349 to create a reference block that can be used in the prediction and coding of a next block. This new reference block is first processed by a deblocking filter unit 330 according to the embodiments in order to perform deblocking filtering to combat any blocking artifact. The processed new reference block is then temporarily stored in a frame buffer 348, where it is available to the intra predictor 349 and the motion estimator/compensator 350.

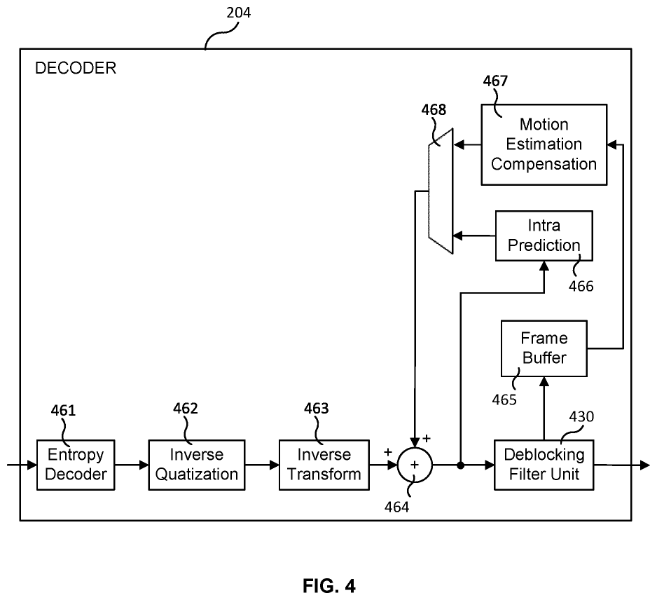

FIG. 4 is a corresponding schematic block diagram of decoder 204 according to some embodiments. The decoder 204 comprises a decoder 461, such as entropy decoder, for decoding an encoded representation of a block to get a set of quantized and transformed residual errors. These residual errors are dequantized in an inverse quantizer 462 and inverse transformed by an inverse transformer 463 to get a set of residual errors. These residual errors are added in an adder 464 to the pixel values of a reference block. The reference block is determined by a motion estimator/compensator 467 or intra predictor 466, depending on whether inter or intra prediction is performed. A selector 468 is thereby interconnected to the adder 464 and the motion estimator/compensator 467 and the intra predictor 466. The resulting decoded block output form the adder 464 is input to a deblocking filter unit 430 according to the embodiments in order to filter any blocking artifacts. The filtered block is output form the decoder 204 and is furthermore preferably temporarily provided to a frame buffer 465 and can be used as a reference block for a subsequent block to be decoded. The frame buffer 465 is thereby connected to the motion estimator/compensator 467 to make the stored blocks of pixels available to the motion estimator/compensator 467. The output from the adder 464 is preferably also input to the intra predictor 466 to be used as an unfiltered reference block.

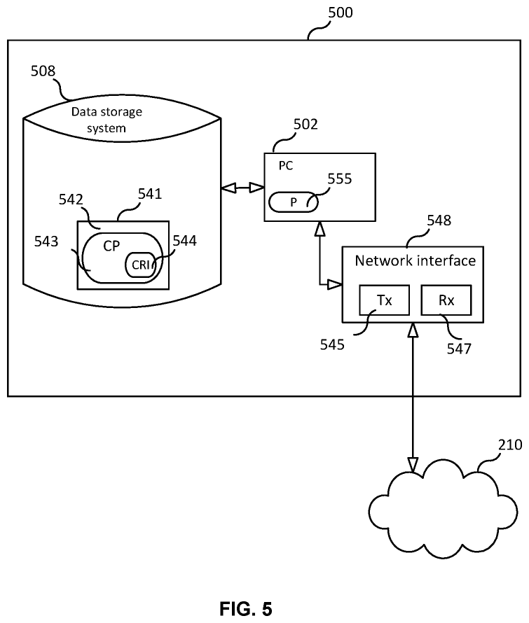

FIG. 5 is a block diagram of an apparatus 500 for implementing decoder 204 and/or encoder 202, according to some embodiments. When apparatus 500 implements a decoder, apparatus 500 may be referred to as a “decoding apparatus 500,” and when apparatus 500 implements an encoder, apparatus 500 may be referred to as an “encoding apparatus 500.” As shown in FIG. 5, apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 500) may be a distributed computing apparatus): at least one network interface 548 comprising a transmitter (Tx) 545 and a receiver (Rx) 547 for enabling apparatus 500) to transmit data to and receive data from other nodes connected to a network 210 (e.g., an Internet Protocol (IP) network) to which network interface 548 is connected (directly or indirectly) (e.g., network interface 548 may be wirelessly connected to the network 210, in which case network interface 548 is connected to an antenna arrangement): and a storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes apparatus 500 to perform steps described herein (e.g., steps described herein with reference to the flow charts). In other embodiments, apparatus 500 may be configured to perform steps described herein without the need for code. That is, for example, PC 502 may consist merely of one or more ASICs. Hence, the features of the embodiments described herein may be implemented in hardware and/or software.

In the description below, various embodiments are described that solve one or more of the above described problems. It is to be understood by a person skilled in the art that two or more embodiments, or parts of embodiments, may be combined to form new embodiments which are still covered by this disclosure.

According to an embodiment, a first source picture from a set of source pictures is downscaled to at least one reduced resolution picture. The similarity between the at least one reduced resolution picture and the corresponding source picture is then compared. The smallest reduced resolution that is sufficiently similar to the first source picture is selected as the encoding resolution for the set of source pictures. In certain aspects, the process is iterative such that multiple reduced resolutions are successively applied to identify the lowest resolution that is still satisfactory (e.g., meets a desired metric). This could include, for instance, generation of multiple reduced resolution pictures and multiple comparisons/determinations regarding similarity. If no reduced resolution provides a reduced resolution picture that is sufficiently similar to the source picture, then full resolution is used to encode this picture.

Examples of down-scaling ratios are 0.5× and 2/3: however, other ratios between source resolution and encoded resolution are also possible, and may be used in embodiments. One example can be illustrated with a source resolution of 3840×2160. Examples of downscaled resolutions in this case would be 2560×1440, 1920×1080, 2560×2160, 3840×1440, 3840×1080 and 1920×2160. Examples of color components for which similarity can be determined are Y (luma), Cb (chroma B), and Cr (chroma R). According to embodiments, downscaling resolution is considered and applied with respect to luma components. However, one or more of the chroma components may further be used in addition to, or in place of, luma components.

In some embodiments, in addition to the first source picture, a second source picture from the set of source pictures is also downscaled to at least one reduced resolution picture. Then the similarity between the at least one reduced resolution picture and the second source picture is compared. The smallest resolution is selected, among the set of reduced resolutions, that fulfils one or more requirements (e.g., for both the first and second picture). For instance, the resolution can be selected where both the first reduced resolution picture, and the second reduced resolution picture, are sufficiently similar to their corresponding source pictures. In certain aspects, if no resolution from the set of reduced resolutions fulfils this requirement (e.g., fails for one or more both of the reduced resolution pictures), then the set of pictures are encoded in full resolution.

According to embodiments, the similarity of the source picture and a reduced resolution picture is determined by upscaling the reduced resolution picture to the source resolution and then computing a distortion (or other metric) between the samples of the two pictures. Distortion may be determined in different ways. For instance, the distortion can be computed as SAD (sum of absolute differences) or SSD (sum of squared differences). An alternative distortion metric is to compute the quality, for example by peak signal to noise ratio PSNR. PSNR could be defined in some examples as follows:

$$\\ PSNR = 10 * log 10 ( 2 \hat{} ( M - 1 ) * 2 \hat{} ( M - 1 ) * K / SSD ) ,$$

where M is the bit-depth to be used for encoding, K is number of samples in the picture, and SSD=sum over x and y (source (x,y)−test(x,y))\hat{ }2, where x and y is sample coordinates within the picture. Other definitions may be used. Another alternative quality metric is the structural similarity index metric (SSIM). Yet another alternative quality metric is the learned perceptual image patch similarity (LPIPS).

According to embodiments, when the distortion (for example SAD) or other metric is below a threshold or the quality (for example PSNR or LPIPS) is above a threshold, the images are regarded as similar. One example threshold using the quality metric PSNR is 38 dB for a luma component of the source picture, for the case when the encoding bit depth is 10. While comparison against a threshold is used in some embodiments, suitability may be determined without an express comparison. For example, suitability may be determined by extracting a value from an index or table (e.g., in array form).

In certain aspects, the level of the threshold can depend on whether noise reduction is used on the source picture or not. For example, the PSNR threshold can be 36 dB for the luma component of the source picture if noise reduction is not employed on the source picture before the similarity comparison.

According to embodiments, the similarity of the source picture and a reduced resolution picture is determined by computing characteristics of at least the source picture, and optionally, also for the reduced resolution picture. The characteristics of the pictures can then be compared.

One example of characteristics that may be used in embodiments is edge strength in the picture(s). Edge strength can, for example, be determined by computing sums of differences between samples horizontally or vertically. One way is to use abs(A−B), where A and B are two adjacent samples. Another example is to use abs(A−2*B+C), where A, B C are adjacent samples vertically or horizontally. According to embodiments, if the edge strengths of the source picture are smaller than a threshold, it can be predicted that the reduced resolution picture will be sufficiently similar to the source picture for the reduced resolution to work well. Thus, and in some embodiments, the suitability of reduced resolution picture may be evaluated based on the characteristics of the source.

According to embodiments, if edge strengths are also computed on the reduced resolution picture, the edge strengths can be compared. In this example, when the absolute value of the difference between the average edge strength in the source picture and the average edge strength in the reduced resolution picture is less than a threshold, the pictures may be regarded as similar.

Another example of a characteristic that may be used is spatial frequency of a picture. Spatial frequency strength can, for example, be determined from magnitudes of transform coefficients of non-overlapped block-based transforms on the source picture. If the larger magnitudes of transform coefficients mainly are located at lower spatial frequencies, e.g., the lower quadrant (half vertically and half horizontally), the picture may be deemed to be suitable for resampling to half resolution both vertically and horizontally. If there are a significant amount of transform coefficient magnitudes in frequencies outside the lower quadrant, the picture may be deemed to not be suitable for resampling to half resolution. One example transform is the Hadamard transform and one example size is 16×16. Using these examples, if the picture resolution is 64×64, then 16 non-overlapped block-based transforms can be applied and then the average transform coefficient magnitudes can be computed. If the average magnitudes outside the lowest frequency quadrant (8×8) are smaller than a threshold the source picture is suitable for rescaling. Another example transform is discrete cosine transform (DCT), and another example transform size is 32×16.

According to embodiments, if spatial frequencies are also computed on the reduced resolution picture or the reduced resolution picture after upscaling to source resolution, the spatial frequency distributions can be compared. If there is a relatively small amount of absolute difference in transform coefficient magnitudes for the pictures they can be regarded as similar. In some cases, the reduced resolution transform coefficients can be inferred or estimated from the transform coefficients of the source resolution picture.

In an embodiment, the amount of similarity required for choosing encoding at a reduced resolution is varied (e.g., reduced) with decreasing quality level. The quality level can be indicated, for instance, by a metric that relates to the expected quantization step size used for quantization of transform coefficients, such as the QP (quantization parameter).

When the quality level is low, details in the source picture may not be kept, and it can actually be subjectively worse to encode at the source resolution than encoding at a lower resolution, even though objective coding efficiency may suggest otherwise. One example QP is around 37. QPs equal to or greater (e.g. equal or lower quality) than this could often benefit from encoding in reduced resolution to a larger extent than higher quality levels.

In an embodiment, the first source picture is a picture to be intra coded or a picture that will be encoded with temporal layer id equal to 0.

One example is encoding in hierarchical B coding with random access configuration with a hierarchy of 32 pictures. In this example, the first source pictures correspond to every 32nd picture in the sequence of pictures. If the sequence of pictures is 64 long, the resolution of pictures 0 to 31 is determined by performance of re-scaling of picture 0, and the resolution of pictures 32 to 63 is determined by performance of re-scaling of picture 32. Another example is encoding in hierarchical B coding with random access configuration with a hierarchy of 16 pictures. In this example, the first source picture is every 16th picture in the sequence of pictures. If the sequence of pictures is 32 long, the resolution of pictures 0 to 15 is determined by performance of re-scaling of picture 0, and the resolution of pictures 16 to 31 is determined by performance of re-scaling of picture 16. Another example is encoding in hierarchical B coding with random access configuration with hierarchy of 8 pictures. In this example the first source picture is every 8th picture in the sequence of pictures. If the sequence of pictures is 16 long, the resolution of pictures 0 to 7 is determined by performance of re-scaling of picture 0, and the resolution of pictures 8 to 15 is determined by performance of re-scaling of picture 8.

In some embodiments, where a second source picture is evaluated, the selection of encoding resolution can (e.g., for a GOP of 32) be based on source picture 0 and source picture 32 for encoding of source pictures between 0 and 31, for a GOP of 16 be based on source picture 0 and source picture 16 for encoding of source pictures between 0 and 15, and for a GOP of 8 be based on source pictures 0 and source picture 8 for encoding of source pictures between 0) and 7.

In another embodiment, where a second source picture is evaluated, the selection of encoding resolution can for a GOP of 32 may be based on source picture 0) and source picture 16 for encoding of source pictures between 0 and 31, for a GOP of 16 be based on source picture 0 and source picture 8 for encoding of source pictures between 0 and 15, and for a GOP of 8 be based on source pictures 0 and source picture 4 for encoding of source pictures between 0 and 7.

In some embodiments, and more generally, the first source picture corresponds to every Nth picture to be coded. The resolution for encoding N pictures is based on the first source picture in each set of N pictures. For example, if N is 4, the encoding resolution of pictures 0 to 3 is determined based on source picture 0, the encoding resolution of pictures 4 to 7 is determined based on source picture 4, etc. In another example, N is equal to 8, the encoding resolution of pictures 0 to 7 is determined based on source picture 0, the encoding resolution of pictures 8 to 15 is determined based on source picture 8, etc.

In some embodiments, the first source picture in a set of source pictures is encoded at source resolution and also encoded after reducing the source resolution. Then it is evaluated to decide which encodings are best in rate distortion cost (lambda*rate+distortion), or another distortion and/or bit-rate metric. In this case, the encoding resolution that has the least rate distortion cost (or other metric) is selected for encoding the other source pictures in the set of source pictures. Thus, and according to some embodiments, the sufficiency of similarity may be based on comparisons or other determinations made using encoded pictures.

One example is to encode the first source picture in source resolution 3840×2160 and also encode the first source picture in resolution 1920×1080, then upscale the encoded picture in reduced resolution and compute the distortion to the first source picture. Then the rate distortion cost for the reduced resolution encoding is cost 1920×1080=bits 1920×1080*lambda+distortion 1920×1080. The rate distortion cost for encoding at the source resolution is also calculated, e.g., cost3840×2160=bits3840×2160*lambda+distortion3840×2160, using the bits for encoding in source resolution respectively the distortion compared to the first source picture. The cost3840×2160 and cost 1920×1080 are then further compared against each other. If the cost3840×2160 is smaller, the remaining source pictures will be encoded at the resolution 3840×2160. Otherwise, the remaining pictures will be encoded at the resolution 1920×1080.

A motivation for this embodiment is that, in some cases, the available time-or power-budget allows for more than one parallel compression. In these cases, the method can be used to find, among a list of several lowered resolutions, two candidate resolutions to try. As an example, if the encoder can choose from 100% (full resolution), 66% (two-thirds resolution in both x-and y-dimensions) and 50% (half resolution in both x- and y-dimensions), then if both 66% and 50% passes the test, the encoder can choose to try both. The resolution among the two that gives the best performance in terms of rate distortion (RD) can then be selected. In another case, perhaps only the 66% passes the test. Then the encoder can choose to try both 66% and 100% and see which one gives the best RD performance.

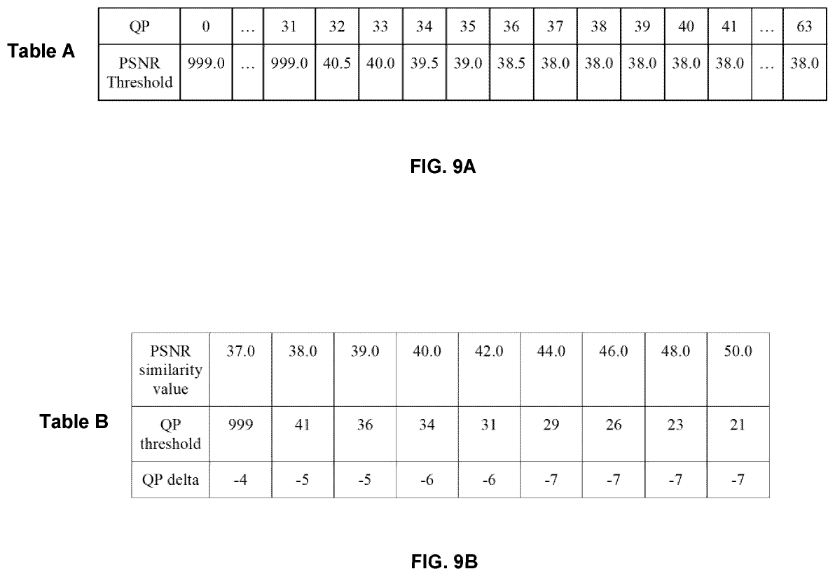

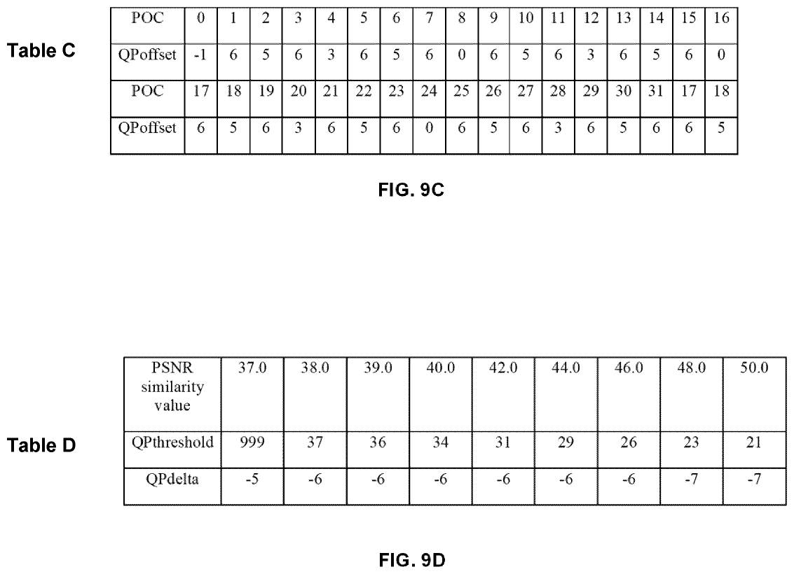

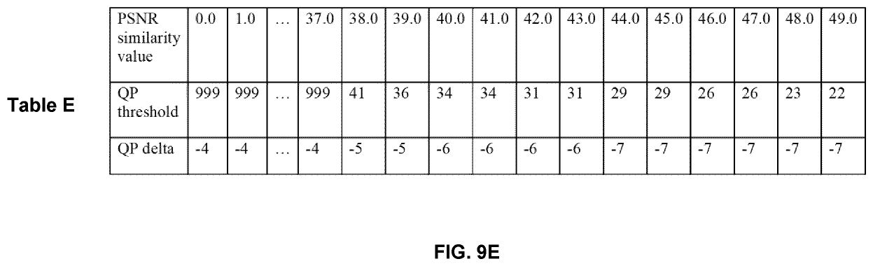

One or more of QP and PSNR may also be used. According to embodiments, a table (such as a look-up table) can be used that associates QP with a PSNR threshold. An example is provided in Table A, which is shown in FIG. 9A. While QP and PSNR are used in this example, other compression values and similarity or distortion metrics may be used according to embodiments.

In certain aspects, a method is provided that reads the QP of the picture to test, and uses the table to obtain a PSNR threshold. As an example, if the picture to test has QP 36, then the table is used to obtain a PSNR threshold of 38.5. The picture to test may then be down-sampled and then up-sampled again, and the PSNR value between it and the non-scaled picture is calculated. If the PSNR is above the PSNR threshold of 38.5, the picture (or the GOP the picture belongs to) is encoded using the downscaled resolution. Otherwise the GOP is encoded using the up-scaled resolution. A reason to have a higher value for low QPs is that, for low QPs, one may be less happy to lower quality for a reduction in bit rate. While a table is described in embodiments, other techniques may implemented to use QP and/or PSNR for encoding resolution determinations. In some embodiments, the mapping between QP and the similarity metric is parameterized. One example of parameterizations is a polynomial model (e.g. linear or non-linear model). Also, and according to embodiments, if other similarity metrics are used, the table may instead have a mapping between QP and the other similarity metric.

According to embodiments, the mapping table is configurable.

According to embodiments, parameters may be used to enable resolution selection control. This could include, for instance, control of sensitivity and/or thresholds for a given method. For instance, configurable parameters can be added to enable control of how careful the selection of encoding in reduced resolution should be, and/or above which QP the method becomes activated for. For instance, a parameter EnableGOPbasedRPR could be used where a value of 1 enables the method, and a value of 0 disables the method. The default may be to have the method turned off, in some embodiments. In some embodiments. a parameter GOPBasedRPRThresholdQP may be used, where a GOP-based RPR check is made for QP>=GOPBasedRPRThresholdQP. In some embodiments, an offset—GOPBasedRPRQPoffset—could be used. In certain aspects, this offset is added to the QP when encoding at reduced resolution. An example value may be −6, which typically gives a similar bitrate when encoding at quarter resolution. In some embodiments, a parameter GOPBasedRPRSimilarity ThresholdLuma can be used. This may cause, for instance, selection and/or encoding in reduced resolution if the PSNR for luma after re-scaling is higher than GOPBasedRPRSimilarity ThresholdLuma. Similarly, a parameter GOPBasedRPRSimilarity ThresholdChroma can be used. This may cause, for instance, selection and/or encoding in reduced resolution if the PSNR for chroma components after re-scaling are both higher than GOPBasedRPRSimilarity ThresholdChroma.

According to embodiments, to be more restrictive in selecting encoding in reduced resolution, the similarity measure for the picture can be based on block-wise similarity measures. A block can, for example, be one fourth of the picture. In that case, four blocks are considered. In certain aspects, the similarity measure for the picture can, for example, be equal to the minimum of the block-wise similarities. Accordingly, if there is some part of the picture that copes badly with re-scaling, encoding in reduced resolution can more likely be avoided.

According to embodiments, to be more flexible in the application of encoding in reduced resolution, the selection could be made block-wise. In certain aspects, a matching capability is provided on the decoder side. In this example, a block of the picture can either be encoded in full resolution, or in reduced resolution and then up-scaled to full resolution. In embodiments, a block of the picture could be 1:4 of the picture, as four blocks of equal size. Alternatively, a block of the picture could be a central part of the picture in quarter resolution, with a second block on the left side and a third block on the right side of the central block. Then a fourth block can be above and a fifth block below the central block. In this example, for 4K (3840×2160) one would have 1080 p (1920×1080) in the middle, then 960×1080 on respective left and right side, then 3240×540 above and below the middle block. The block of the picture could also be a CTU (Coding Tree Unit). Example sizes may be, for instance, 128×128 or 256×256.

In certain aspects, for each source block it may be necessary to determine block resolution for encoding, and in some instance, also encode (or otherwise transmit) an indication of the selected block resolution. This could be used by the decoder to decode the indication and use correct block dimensions, for instance, when decoding the block and then upscaling samples of the decoded block to the resolution of the source block if needed. The resolution of the block to be encoded can, for example, be one quarter of the size of the source block. In certain aspects, the determination of block resolution can be made based on similarity metric or rate distortion cost as in other embodiments. The decision on which to use may be based on computational capabilities in some embodiments.

Additionally, the block resolution could also be determined to be specific to the luma and/or chroma components. In this example, it may also be necessary to indicate the luma block and chroma block resolution. One option is to only encode the luma source block in reduced resolution.

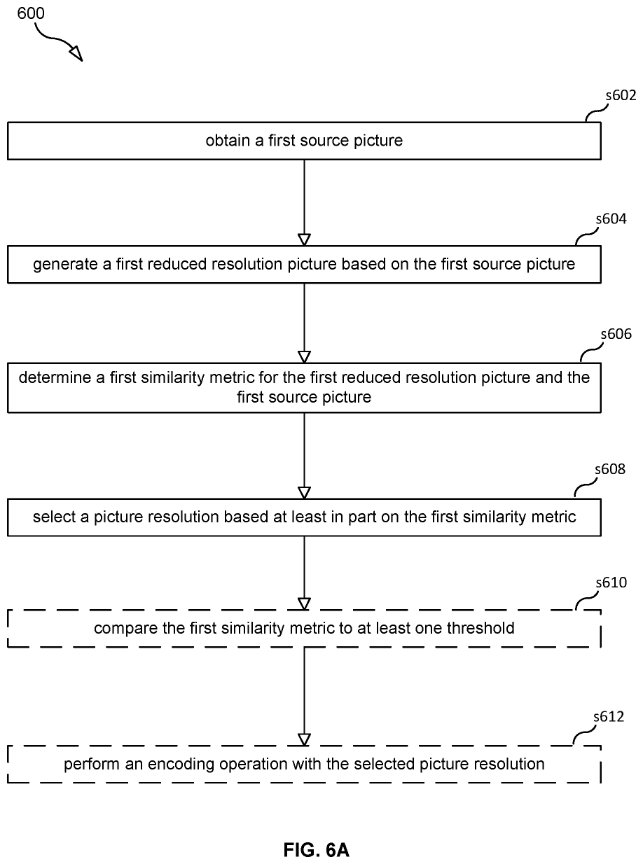

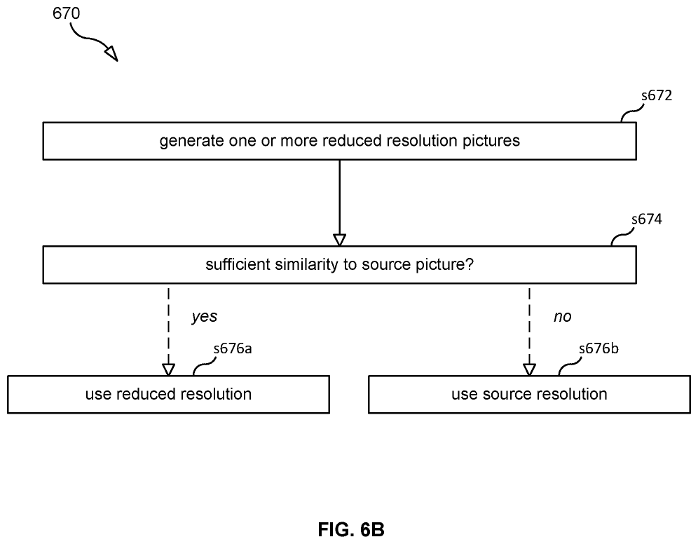

Referring now to FIG. 6A, a process 600 is provided according to some embodiments. The process may be performed for instance, by one or more of the devices shown with respect to FIGS. 2-5.

The process 600 may begin, for instance, with step s602 where a first picture is obtained. This may comprise, for instance retrieving, receiving, and/or deriving a picture from a set of pictures comprising a video sequence. In embodiments, the process 600 is applied using RPR with a VVC video segment. In step s604, a first reduced resolution picture is generated based on the first source picture. The reduced resolution picture may be generated, for instance, by applying a scaling filter (e.g., based on interpolation in one or more of the luma and/or chroma components). In step s606, a first similarity metric is determined for the first reduced resolution picture and the first source picture. Evaluation of the similarity may comprise up-scaling a reduced resolution picture to source resolution. In some embodiments, similarity metrics and/or determinations are made using un-encoded pictures, while in others, encoded pictures are used. In some embodiments, the first similarity metric comprises determining a characteristic (e.g., edge strength or spatial frequency) for one or more of the first reduced resolution picture (or an encoded or up-scaled version thereof) and the first source picture. In step s608, a picture resolution is selected based at least in part on the first similarity metric. In steps s610, which may be optional in embodiments, the first similarity metric is compared to at least one threshold. In steps s612, which may also be optional in some embodiments, an encoding operation is performed with the selected resolution. According to embodiments, the selected resolution is used to encode a set of pictures. For instance, the first source picture may be part of a set of pictures, where the selected resolution is used for the entire set of pictures during the encoding operation. In certain aspects, the process 600 may comprise performing encoding with a resolution of the first source picture when the threshold is not satisfied: and encoding with a resolution of the first reduced resolution picture when the threshold is satisfied. The selected resolution may also be communicated, for instance, by transmitting it from the encoder-side to the decoder-side (e.g., as part of the encoded information).

In some embodiments, the process 600 may have one or more iterative aspects. For instance, one or more of steps s604, s606, s608, and s610 may be performed multiple times. This can identify the smallest reduced resolution for which the first reduced resolution picture and the first source picture are sufficiently similar. For instance, the process 600 may comprise generating multiple reduced resolution pictures, determining a similarity metric for each of the multiple reduced resolution pictures, and selecting the smallest resolution for which a corresponding similarity metric meets one or more criteria.

According to embodiments, one or more steps of process 600 can be applied at the block level of a picture.

Referring now to FIG. 6B, a process 670 is provided according to some embodiments. The process may be performed for instance, by one or more of the devices shown with respect to FIGS. 2-5. Additionally, the process 670 may be performed, for instance, as part of a determination or resolution selection process, such as described in connection with process 600 and FIG. 6A. In step s672, one or more reduced resolution pictures is generated. In step s674, a determination is made as to whether the reduced and source resolutions are sufficiently similar. This may be based, for instance, on any of the metrics and evaluations/comparisons described herein. If they are sufficiently similar (“yes”), a reduced resolution is used at step s676a for encoding a set of pictures. If they are not sufficiently similar (“no”), the source resolution may be used for step s676b. In embodiments, steps s676a-b may be used, for instance, in connection with the encoding step(s) of process 600.

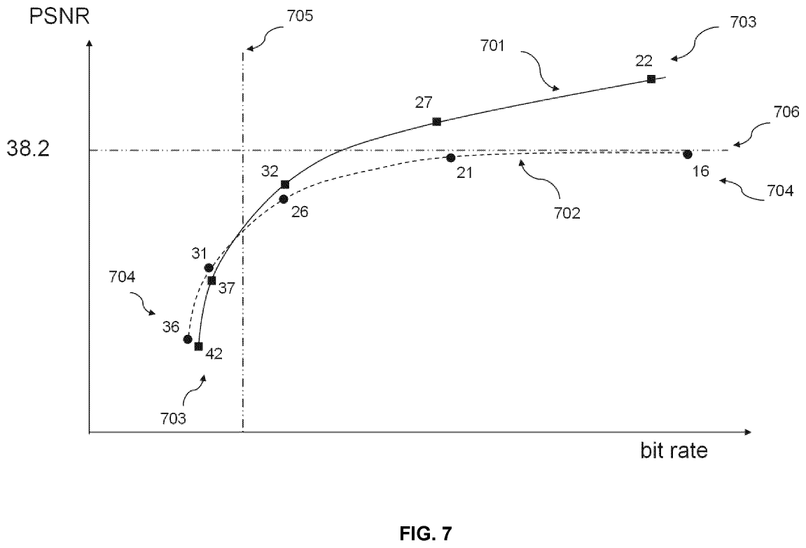

Referring now to FIG. 7, an example of a rate/distortion (or rate/quality) curve of a picture (or group of pictures) is illustrated. In this example, the solid line 701 represents the picture when compressed at full resolution using five different QP values giving five different points 703 in the diagram: QP 22, QP 27, QP 32, QP 37 and QP 42. Each point has a bit rate and a PSNR, representing the x- and y-positions in the diagram respectively. The dashed line 702 represents the rate/distortion curve of the picture when compressed at half resolution using five different QP points 704: QP 16, QP 21, QP 26, QP 31 and QP 36. As shown in the example of FIG. 7, increasing the bit rate (lowering the QP) for the dashed line gives diminishing returns. A reason is that, even if the lower resolution picture is compressed without error, it will still incur an error compared to the full resolution version. In this example, the PSNR is calculated between the uncompressed full resolution picture and the uncompressed half resolution picture to be a PSNR value of 38.2 dB. This value then becomes an upper limit for the quality of the half resolution sequence. In the example of FIG. 7, this limit is illustrated with the asymptotic line 706. Typically, at lower bit rates, it is often preferable to subsample the picture to half resolution before compressing, as illustrated by the fact that the dashed curve 702 is above the solid curve 701 in the left most part of the diagram. In certain aspects, the crossover happens approximately where QP=36 for the solid curve. This cutoff is shown as the line 705 in the diagram. Also, in certain aspects, the crossover happens approximately where QP is six units lower (QP=30) for the dashed curve.

Accordingly, and in some embodiments, if the self-similarity (e.g., the PSNR between the source picture and the uncompressed down-sampled source image) is sufficiently high, such as above a certain threshold value (for instance 38.0), the unscaled source picture will be used for QP points lower than 36. However, for lower bit rates, the down-sampled pictures will be used, with a QP six units lower. Thus, the unscaled picture will be used for QP 22, 27 and 32 in this example, but instead of using the unscaled picture for QP 37 and QP 42, the down-sampled picture will be compressed at QP 37−6=31 and QP 42−6=36.

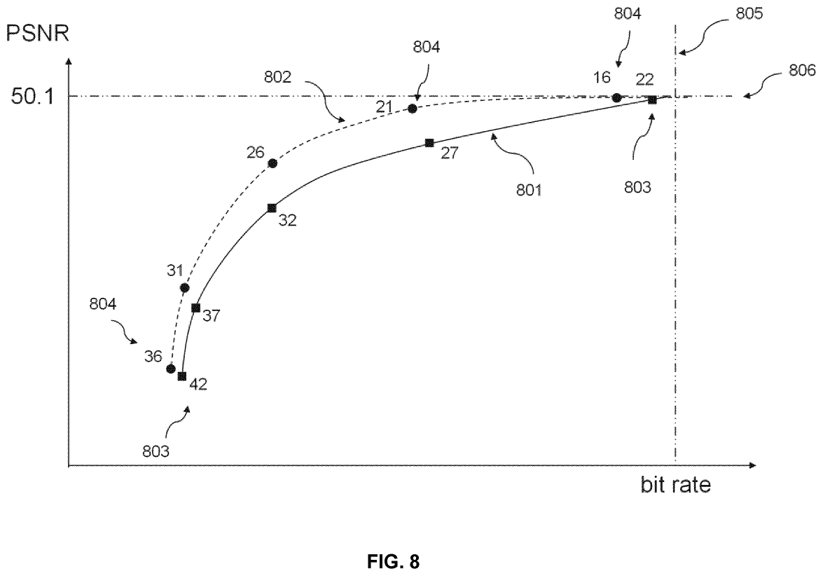

While this example may be applied in many cases, for some pictures/group of pictures/sequences it may be possible achieve better results (in certain respects). An example is provided in FIG. 8. In this illustration, the solid line (801) again represents a picture when compressed at full resolution. However, the particular picture in this example does not contain much fine detail. This means that when down-sampling it to half resolution and up-sampling it again, the PSNR score is very high at 50.1 dB, as illustrated by the asymptotic line 806. This means that the dashed line 802, which represents the rate/distortion (or rate/quality) curve for the down-sampled sequence, will be higher than in the example of FIG. 7. This is evident especially at the right part of the diagram. In certain aspects and in examples, it can even be so high so that it never crosses with the solid curve, at least not for the QPs that may be of interest. This is illustrated by the crossover line 805 being to the right of all the QP points in the diagram. In such a situation, it is likely beneficial to use the down-sampled picture for all bit rates. Hence, QP points 16, 21, 26, 31 and 36 are used from the down-sampled picture, and no QP points are used from the original resolution picture in the example. Here, a high similarity score (such as 50.1 dB) between the original resolution source and the down-sampled source indicates that one should use the down-sampled picture for higher bit rates than if a low similarity score (such as 38.2 dB) was observed.

According to embodiments, a QP threshold is decided as a function of the similarity PSNR value. One example is to use a table, such as Table B, which is shown in FIG. 9B.

As an example, if the PSNR similarity value is larger than or equal to 42.0, then one should use full resolution for all QPs from 0 to QP=31. But for QP 32, one may instead use the down-sampled source picture with QP=32+QP_delta=32−6=26. Likewise for QP 31, one would instead use the down-sampled source picture with QP=31+QP_delta=31−6=25, etc. If there is a high PSNR similarity value, such as 50.1, since it is larger than 50.0 one can use the right most column of Table B. Hence, the original resolution will not be used for any QPs larger than 21. As an example, if one used QP=22 for the original resolution, they would instead encode the picture/GOP/sequence using the down-sampled source material at QP=22+QP_delta=22−7=15.

In certain aspects, any of the foregoing embodiments or combination of embodiments may be applied using RPR in VVC.

Some examples of filters for rescaling, including down-sampling, may be found, for instance, in the VVC specification. For example, JVET-T2001-v21 describes luma and chroma re-scaling using interpolation filters at Sections 8.5.6.3.2 and 8.5.6.3.4, respectively. According to embodiments, depending on the difference in resolution between the source picture and the reduced resolution picture (e.g., scaling ratio), different sets of filters may be selected and applied.

An example for selecting resolutions is provided below, which illustrates aspects of some embodiments.

In this example, a 320-picture long sequence of video pictures P0, P1, P2, . . . , P319 is used, which is divided into GOPs of size 32. The first GOP will be P0, P1, P2, . . . , P31, the second GOP will be P32, P33, P34, . . . , P63 and the tenth GOP will be frames P288, P289, . . . , P319. In this example, and according to current software, the resolution in the middle of a GOP is not changed, but there can be a change the resolution at every GOP. Hence, the first GOP can have full resolution (for instance, 1920×1080) whereas the second GOP can have half resolution (960×540), the third GOP can have full resolution again, etc. Typically, one would also have a certain quality target or bit rate target for the GOP. This target could change from GOP to GOP, for instance, if one wanted to lower the bit rate based on channel capacity. The quality and bit rate can be controlled with QP, where a high QP gives a low quality and low bit rate and a low QP gives a high quality and high bit rate. Typically there is a “baseQP” for a GOP, for instance 37. In the current software, for instance, one may have the same QP for the entire sequence (i.e., baseQP=sequenceQP), for instance 37. Each picture in the GOP then gets an individual QP (called sliceQP in VVC) by adding a QPoffset that is determined by the position of the picture within the GOP. As an example, for the first 32 frames, QPoffset is determined based on the picture number (or “Picture Order Count”, POC) as shown in Table C of FIG. 9C.

As shown in FIG. 9C, picture PO gets an offset of −1, which means that if the baseQP is 37, the sliceQP for that picture is 37-1=36. Likewise, P1 gets an offset of +6, meaning that the sliceQP for P1=37+6=43. For frames above 31, one could take the POC value modulus 32 to get the POC to use from the table. As an example, P33 will use 33 mod 32=1, so its QPoffset will be 6 and the sliceQP for P33 will be 37+6=43. The sliceQP can also be controlled by an additional offset QPoffset2 (added to the above derivation of sliceQP) which is equal to clip (0),3, (baseQP+QPoffset) * QPOffsetModelScale+QPOffsetModelOff) where QPOffsetModelOff and QPOffsetModelScale can be specific for each POC. If the QPOffset model parameters are non-zero, a further change of sliceQP by 0) to 3 at most can happen (e.g. in this example sliceQP=37+6+QPoffset2).

According to embodiments, and with further reference to the example discussed above, before encoding a GOP (for instance the second GOP containing P32, P33, . . . , P63), the first picture in the GOP (P32) is processed. For instance, it is down-scaled to half resolution in both x and y, and up-scaled again to full resolution. Then the PSNR score/PSNR similarity value for the down-and up-sampled image is calculated using the unscaled source image as the reference. Assume the value becomes 46.2 dB in this example. One can now compare this value against a threshold (e.g.,

GOPBasedRPRSimilarity ThresholdLuma). Assume the threshold is 38.0 dB in this example. In this case, the similarity value passes the test. This means that there is a potential that this GOP will be encoded in lower resolution. However, and according to embodiments, this still depends on the baseQP. If the baseQP is very low, it may not be advisable to lower the resolution even though the PSNR similarity passed the test. The reason is that low QPs typically mean that good quality may be desirable. Therefore, and according to embodiments, an additional check of the baseQP is performed against another threshold, called GOPBasedRPRThresholdQP in this example. Here, the baseQP is 37, and since GOPBasedRPRThresholdQP=37, it just passes also this test. This means that the second GOP (P32, P33, . . . , P63) should be coded at half resolution in the x-and y-dimension. However, since down-scaling lowers the bit rate quite considerably, one can compensate for that by also lowering the QP for all the individual pictures. This is the value QPdelta, which in this example is called GOPBasedRPRQPoffset, and set to the example value −6. Therefore, the downscaled picture P32 will get sliceQP=baseQP+QPoffset+QPdelta=37+(−1)+(−6)=30. Likewise P33 will get sliceQP=37+6+(−6)=37, and so forth.

According to some embodiments, and with further reference to the example above, before encoding a GOP (for instance the second GOP containing P32, P33, . . . , P63), the first picture in the GOP (P32) is processed, and the PSNR score/PSNR similarity value are calculated in the same way as described above. Table D, which is shown in FIG. 9D, may also be used.

For example, one can use the PSNR similarity value to find the QP threshold and QP delta using Table D. Assuming again that the value was 46.2, one can use the column corresponding to 46.0 and obtain the QPthreshold=26 from the table. In certain aspects, this value is similar to the GOPBasedRPRSimilarity ThresholdLuma discussed elsewhere. One can now check the baseQP against this value. Assuming again that the baseQP=37, it passes this threshold, 37>26, and since the rule is to be larger than or equal to QPthreshold. This means that the entire GOP should be down-sampled in both the x-and y-dimensions before encoding. Next, one gets QPdelta from the same column. In certain aspects, QPdelta is similar to the GOPBasedRPRThresholdQP discussed elsewhere. This is the value added to all the sliceQPs in order to compensate for the lowered resolution. Since this value is 6, the downscaled picture P32 will get sliceQP=baseQP+QPoffset+QPdelta=37+(−1)+(−6)=30. Likewise P33 will get sliceQP=37+6+(−6)=37, and so forth. The sliceQP can also be controlled by an additional offset QPoffset2 which is equal to clip (0),3, (baseQP+QPoffset+QPdelta)*QPOffsetModelScale+QPoffsetModelOff), where QPOffsetModelScale and QPOffsetModelOff can be specific for each POC. Thus, sliceQP for P32 can get sliceQP=baseQP+QPoffset+QPdelta+QPoffset2.

As shown above, both of these embodiments give the same result in this particular case. However, if the baseQP would be lower, there may be differences. As an example, if the baseQP=27, then the first embodiment of the example would not choose to down-sample since it would not pass the second check of baseQP>=GOPBasedRPRThresholdQP. However, the second embodiment of the example would choose to down-sample here, since baseQP is now compared against QPthreshold=26 instead. However, if the PSNR similarity value was much lower, say 38.2, then both embodiments would again make the same decision.

Embodiments use an example of QP control of an encoder, for instance, the VVC reference encoder. However, and in certain aspects, other encoders may have other ways to derive slice QP and also change QP locally block by block.

In some embodiments, a table of values may be used-and one or more methods implemented—without an explicit comparison. For instance, a table may be expanded such that the difference between any two similarity values (e.g., PSNR) is the same, such as 1.0 db. An example is shown in Table E of FIG. 9E.

In embodiments, this can be implemented using two arrays:
int QP_threshold_tab [51]=[999, 999, . . . , 999, 41, 36, 34, 34, 31, 31, 29, 29, 26, 26, 23, 22]; and
int QP_delta_tab [51]=[−4, −4, . . . , −4, −5, −5, −6, −6, −6, −6, −7, −7, −7, −7, −7, −].

Additionally, if one has the similarity value (e.g., in floating point form), the values of QP_threshold and QP_delta can be obtained by rounding the value to the nearest lowest integer:
int sim_met_integer=floor (sim_met),
   where the floor (·) function rounds down and is used as index to fetch numbers from the table:

int QP_threshold = QP_threshold_tab[sim_met_integer];
int QP_delta = QP_delta_tab[sim_met_integer].

In some embodiments, the similarity metric is the result of processing of an intermediate value.

### Summary of Various Examples

A1. A method for determining resolution for encoding, comprising: obtaining (e.g., retrieving, receiving, and/or deriving) a first source picture: generating a first reduced resolution picture based on the first source picture: determining a first similarity metric for the first reduced resolution picture and the first source picture: selecting a picture resolution based at least in part on the first similarity metric, and performing an encoding operation with the selected picture resolution.
A2. The method of A1, wherein selecting a picture resolution comprises: comparing the first similarity metric to at least one threshold (e.g., to determine if the first reduced resolution picture and the first source picture are sufficiently similar).
A3. The method of A2, wherein the encoding operation comprises: encoding with a resolution of the first source picture when the threshold is not satisfied; and encoding with a resolution of the first reduced resolution picture when the threshold is satisfied.
A4. The method of any of A1-A3, wherein generating the first reduced resolution picture comprises downscaling the first source picture by applying a re-scaling filter (e.g., by applying an interpolation filter to luma and/or chroma components of the first source picture).
A5. The method of any of A1-A4, wherein performing an encoding operation comprises applying reference picture resampling (RPR) to a Versatile Video Coding (VVC) video segment.
A6. The method of any of A1-A5, wherein selecting a picture resolution comprises iteratively applying different resolutions when generating the first reduced resolution picture to identify the smallest reduced resolution for which the first reduced resolution picture and the first source picture are sufficiently similar (e.g., generating multiple reduced resolution pictures, determining a similarity metric for each of the multiple reduced resolution pictures, and selecting the smallest resolution for which a corresponding similarity metric meets one or more criteria).
A7. The method of any of A1-A6, wherein the first source picture is part of a set of pictures, and wherein the selected resolution is used for the entire set of pictures during the encoding operation.
A8. The method of any of A1-A7, further comprising: obtaining a second source picture: generating a second reduced resolution picture based on the second source picture: determining a second similarity metric for the second reduced resolution picture and the second source picture: selecting a picture resolution based at least in part on both the first and second similarity metrics.
A9. The method of A8, wherein selecting a picture resolution comprises selecting the smallest resolution among a set of at least one reduced resolutions such that both the first reduced resolution picture and the second reduced resolution picture are sufficiently similar to their corresponding source pictures (e.g., both the first and second similarity metrics satisfy one or more criteria or meet a threshold).
A10. The method of A8 or A9, wherein the encoding operation comprises encoding with the source resolution when at least one of the first and second similarity metrics does not meet a threshold.
A11. The method of any of A1-A10, wherein determining the first similarity metric comprises: upscaling the first reduced resolution picture to the resolution of the first source picture to generate an up-scaled picture: and comparing the up-scaled picture to first source picture.
A12. The method of A11, wherein the comparing comprises determining one or more of:
   (i) distortion between the pictures:
   (ii) a sum of absolute differences (SAD) or sum of squared differences (SSD) between the pictures:
   (iii) a peak signal to noise ratio (PSNR) based on the pictures:
   (iv) a structural similarity index metric (SSIM): or
   (v) a learned perceptual image patch similarity (LPIPS).
A13. The method of any of A2-12, wherein the threshold is set based at least in part on:
   (i) use of noise reduction in the first source picture:
   (ii) encoding bit depth: or
   (iii) quality level of a picture (e.g., expected quantization step size used for quantization of transform coefficients, such as the quantization parameter (QP)), wherein the amount of similarity required for selecting a reduced resolution is reduced with decreasing quality level
A14. The method of any of A1-A13, wherein determining the first similarity metric comprises determining a characteristic (e.g., edge strength or spatial frequency) for one or more of the first reduced resolution picture (or an encoded or up-scaled version thereof) and the first source picture.
A15. The method of A14, wherein a reduced resolution is used for encoding when:
   (i) the absolute value of the difference between the average edge strength in the first source picture and the average edge strength in the first educed resolution picture is less than a threshold:
   (ii) magnitudes of transform coefficients of non-overlapped block-based transforms on the first source picture are located at lower spatial frequencies (e.g., the lower quadrant (half vertically and half horizontally)): or
   (iii) an amount of absolute difference in transform coefficient magnitudes for spatial frequency distributions meets a threshold.
A16. The method of any of A1-A15, wherein the first source picture is a picture to be intra coded or a picture that will be encoded with a temporal layer id equal to 0.
A17. The method of A8, wherein a set of pictures between the first and second source pictures are encoded according to the selected resolution.
A18. The method of A8, wherein the first and second source pictures are part of a set of pictures, and the entire set is encoded according to the selected resolution.
A19. The method of A18, wherein at least one of the first or second source pictures is neither a first nor last picture of the set (e.g., a picture in the middle of a GOP).
A20. The method of any of A1-A19, wherein the first source picture corresponds to every Nth picture to be coded in a set and the resolution for encoding N pictures is based on the first source picture in each set of N pictures.
A21. The method of any of A2-A20, wherein the threshold is determined using a look-up table of varied thresholds (e.g., relating QP to variable PSNR or other similarity metric thresholds).
A22. The method of any of A2-A20, wherein the threshold is variable and is determined based on a mapping (e.g., a parametrized mapping with linear or non-linear polynomial model) between QP and the similarity metric (e.g., PSNR).
A23. The method of any of A1-A22, wherein the similarity metric is a block-wise similarity between the first source picture and the reduced resolution picture.
A24. The method of A23, wherein the similarity metric is equal to the minimum of a plurality of block-wise similarity metrics.
A25. The method of any of A1-A24, wherein selecting the picture resolution is for a block of the source picture, and wherein performing the encoding operation comprises encoding the block with the selected picture resolution.
A26. The method of any of A23-25, wherein:
   (i) the block is a quarter of a picture:
   (ii) the block is a central part of a picture (e.g., in quarter resolution); or
   (iii) the block is a Coding Unit Tree (CTU).
A27. The method of any of A1-A26, wherein performing an encoding operation comprises encoding an indication of one or more of: (i) the selected resolution; or (ii) luma and/or chroma resolutions.
A28. The method of any of A1-A27, further comprising: transmitting the encoded picture and/or a resolution indication from an encoder to a decoder.
A29. The method of any of A1-A28, further comprising: performing and additional encoding, wherein the first source picture is encoded at the source resolution to generate a first encoded picture, and wherein the first reduced resolution picture is generated by encoding the first source picture at a reduced resolution.
A30. The method of A29, wherein the first similarity metric is determined based on a comparison of two encoded pictures (e.g., the first encoded picture and the encoded first reduced resolution picture).
A31. The method of A29 or A30, wherein the first similarity metric is based on bit rate and/or distortion.
A32. The method of any of A29-A31, wherein the first similarity metric is rate distortion cost.
A33. The method of any of A29-32, wherein determining the first similarity metric comprises one or more of: (i) upscaling the encoded first reduced resolution picture and computing a distortion value: and (ii) computing a distortion for the first encoded picture.
A34. The method of any of A29-33, wherein the first source picture is part of a set of pictures, and wherein performing the encoding operation uses the selected resolution for the entire set of pictures.
A35. The method of any of A1-A34, wherein selecting the picture resolution comprising retrieving a compression value (e.g., a QP value, a QP threshold, or a QP delta) based at least in part on the first similarity metric.
A36. The method of A35, wherein the value is retrieved from a table (e.g., implemented in array form).
A37. The method of any of A1-A36, wherein determining the first similarity metric comprises determining (e.g., computing) an intermediate similarity value.

B1. An apparatus (e.g., encoder or network node) adapted to perform any of the methods of A1-A37.

B2. An apparatus (e.g., decoder) adapted to receive and process encoded video generated according to the method of any of A1-A37.

C1. A computer program comprising instructions that when executed by processing circuitry of an apparatus (e.g., encoder) causes the apparatus to perform the method of any of A1-A37.

C2. A carrier containing the computer program of C1, wherein the carrier is one of an electronic signal, an optical signal, a radio signal, and a computer readable storage medium.

D1. An apparatus, comprising: a memory; and a processor, wherein the processor is configured to perform the method of any of A1-A37.

D2. The apparatus of D1, wherein the apparatus is an encoder.

El. An apparatus, wherein the apparatus is adapted to: obtain (e.g., retrieve, receive, and/or derive) a first source picture: generate a first reduced resolution picture based on the first source picture; determine a first similarity metric for the first reduced resolution picture and the first source picture: select a picture resolution based at least in part on the first similarity metric, and perform an encoding operation with the selected picture resolution.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-33. canceled

34. A method for determining resolution, comprising:
obtaining a first source picture;
generating a first reduced resolution picture based on the first source picture;
determining a first similarity metric for the first reduced resolution picture and the first source picture, wherein determining the first similarity metric comprises:
(i) upscaling the first reduced resolution picture to the resolution of the first source picture to generate an up-scaled picture, and
(ii) comparing the up-scaled picture to the first source picture;
selecting a picture resolution based at least in part on the first similarity metric; and
performing an encoding operation with the selected picture resolution, wherein:
selecting a picture resolution comprises comparing the first similarity metric to at least one threshold;
the encoding operation comprises encoding with a resolution of the first source picture when the threshold is not satisfied, and encoding with a resolution of the first reduced resolution picture when the threshold is satisfied;
generating the first reduced resolution picture comprises downscaling the first source picture by applying a rescaling filter;
applying a re-scaling filter comprises applying an interpolation filter to one or more luma or chroma components of the first source picture; and
the first source picture is part of a set of pictures, and wherein the selected resolution is used for the entire set of pictures during the encoding operation.

35. The method of claim 34, wherein performing an encoding operation comprises applying reference picture resampling (RPR) to a Versatile Video Coding (VVC) video segment.

36. The method of claim 34, wherein the set of pictures is a group of pictures (GOP) and all pictures in the GOP are encoded at a reduced resolution.

37. The method of claim 34, wherein:
comparing the up-scaled picture to the first source picture comprises determining one or more of:
(i) distortion between the pictures;
(ii) a sum of absolute differences (SAD) or sum of squared differences (SSD) between the pictures;
(iii) a peak signal to noise ratio (PSNR) based on the pictures;
(iv) a structural similarity index metric (SSIM); or
(v) a learned perceptual image patch similarity (LPIPS).

38. The method of claim 34, wherein the threshold is set based at least in part on:
(i) use of noise reduction in the first source picture;
(ii) encoding bit depth; or
(iii) quality level of a picture.

39. The method of claim 38, wherein the quality level of a picture is a quantization parameter (QP).

40. The method of claim 34, wherein the first source picture is a picture to be intra coded or a picture that will be encoded with a temporal layer id equal to 0.

41. The method of claim 34, wherein the first source picture corresponds to every Nth picture to be coded in a set and the resolution for encoding N pictures is based on the first source picture in each set of N pictures.

42. The method of claim 34, wherein the threshold is variable and is determined based on a mapping between a quality level of a picture and the similarity metric.

43. The method of claim 34, wherein one or more of the selected resolution or the threshold is based at least in part on a quantization parameter (QP) and a peak signal to noise ratio (PSNR) between the up-scaled picture and the first source picture.

44. The method of claim 34, wherein:
selecting the picture resolution is for a block of the source picture;
performing the encoding operation comprises encoding the block with the selected picture resolution wherein:
(i) the block is a quarter of a picture;
(ii) the block is a central part of a picture; or
(iii) the block is a Coding Unit Tree (CTU); and
performing an encoding operation comprises encoding an indication of one or more of: (i) the selected resolution; and (ii) one or more of luma or chroma resolutions.

45. The method of claim 34, further comprising:
transmitting the encoded picture.

46. The method of claim 34, further comprising:
transmitting a resolution indication from an encoder to a decoder.

47. The method of claim 34, further comprising:
performing an additional encoding operation, wherein the first source picture is encoded at the source resolution to generate a first encoded picture, wherein:
the first reduced resolution picture is generated by encoding the first source picture at a reduced resolution;
the first similarity metric is determined based on a comparison of the first encoded picture and the encoded first reduced resolution picture; and
the first similarity metric is based on one or more of bit rate or distortion.

48. The method of claim 34, wherein selecting the picture resolution comprises retrieving a compression value based at least in part on the first similarity metric.

49. The method of claim 48, wherein the compression value is one or more of a quantization parameter (QP) value; a QP threshold; or a QP delta.

50. The method of claim 34, wherein the first reduced resolution picture has a resolution of two-thirds or half of the resolution of the source picture.

51. An apparatus, wherein the apparatus comprises processing circuitry and a memory containing instructions executable by the processing circuitry, whereby the apparatus is configured to:
obtain a first source picture;
generate a first reduced resolution picture based on the first source picture;
determine a first similarity metric for the first reduced resolution picture and the first source picture, wherein determining the first similarity metric comprises:
(i) upscaling the first reduced resolution picture to the resolution of the first source picture to generate an up-scaled picture, and
(ii) comparing the up-scaled picture to the first source picture;
select a picture resolution based at least in part on the first similarity metric; and
perform an encoding operation with the selected picture resolution, wherein selecting a picture resolution comprises comparing the first similarity metric to at least one threshold.

52. The apparatus of claim 51, wherein the apparatus is an encoder, decoder, or network node.

53. A computer program product comprising a non-transitory computer readable medium storing instructions which when performed by processing circuitry of a device causes the device to perform the steps of claim 34.
